(19) United States
(12) Patent Application Publication
(10) Pub. No.: US 2011/0305025 A1
(43) Pub. Date: Dec. 15, 2011

(54) LED-BASED LAMPS AND THERMAL MANAGEMENT SYSTEMS THEREFOR

(75) Inventor: Damien Gerard Loveland, Richmond (CA)

(73) Assignee: KONINKLIJKE PHILIPS ELECTRONICS N.V., EINDHOVEN (NL)

(21) Appl. No.: 13/203,495

(22) PCT Filed: Jan. 29, 2010
(86) PCT No.: PCT/IB10/50410

§ 371 Date: Aug. 26, 2011

Related U.S. Application Data
(60) Provisional application No. 61/155,982, filed on Feb. 27, 2009.

(51) Int. Cl. F21V 29/00

(52) U.S. Cl. 362/294

(57) ABSTRACT

Disclosed herein is a lamp including an LED-based light source (54) configured to emit light and an optically transmissive window (50) optically and thermally coupled to the light source, wherein the optically transmissive window is configured to radiate heat generated by the light source to the ambient. The lamp may further include an optical system optically coupled to the light source and configured to redirect the light towards the optically transmissive window.

### TECHNICAL FIELD

The present disclosure is directed generally to thermal management of light sources. More particularly, various inventive methods and apparatus disclosed herein relate to lamps employing LED-based light sources configured to effectively dissipate heat into the ambient via thermal radiation.

### BACKGROUND

Digital lighting technologies, i.e. illumination based on semiconductor light sources, such as light-emitting diodes (LEDs), offer a viable alternative to traditional fluorescent, HID, and incandescent lamps. Functional advantages and benefits of LEDs include high energy conversion and optical efficiency, durability, lower operating costs, and many others. Recent advances in LED technology have provided efficient and robust full-spectrum lighting sources that enable a variety of lighting effects in many applications. Some of the lighting fixtures and luminaires embodying these sources feature a lighting module, including one or more LEDs capable of producing different colors, e.g. red, green, and blue, as well as a processor for independently controlling the output of the LEDs in order to generate a variety of colors and color-changing lighting effects, for example, as discussed in detail in U.S. Pat. Nos. 6,016,038 and 6,211,626, incorporated herein by reference.

Despite improving efficiencies, various types of modern light sources can still produce substantial amounts of heat. This may be of considerable consideration in the configuration of lamps employing corresponding light sources. Lamps based on incandescent light sources, for example, can dissipate large portions of generated heat in the form of infrared radiation. Other types of light sources, including LEDs, generally do not dissipate heat via infrared radiation as effectively as incandescent light sources.

A capability to dissipate heat from a light source or a lamp may both be considered an advantage as well as a disadvantage depending on the nature of the lamp. It may be beneficial for cooling the light source as well as the lamp but it may also be considered a disadvantage when there is a need to retain heat in a filament of an incandescent light source and maintain the filament at a predetermined temperature. In fact, luminaires employing incandescent light sources are designed to retain heat to be able to maintain a stable, sufficiently high operating temperature of the filament and dissipate only so much heat into the ambient to safely operate the lamp. In contrast, LED-based light sources, for example, are generally configured to maintain the LEDs at a predetermined, generally low operating temperature in order to maintain useful life and operational characteristics of the LED-based light sources.

Irrespective of the type of light source used in a lamp or luminaire, its design is generally determined by at least two requirements—firstly, by the ability to illuminate the environment in a predetermined manner, and secondly, by the type of light sources used. While the first requirement generally determines the optical design of the luminaire, the latter determines heat dissipation characteristics among the components of the luminaire, as well as between the luminaire and the ambient environment.

When it comes to cooling LED-based light sources, a number of aspects need to be considered. While capable of converting electrical energy into light more efficiently than incandescent lamps, LEDs can generate considerable amounts of waste heat. Moreover, LEDs generally generate light and heat concentrated in small areas within and surrounded by solid material structures, which, while being reasonably transmissive in the visible portion of the electromagnetic spectrum, may prohibit the effective dissipation of heat via infrared radiation. This can be a specifically challenging consideration in the design of LED-based light sources for space illumination.

For example, while it is possible to use an active cooling via a fan for a luminaire employing LED-based light sources, this may cause another problem, in that the lifetime of a fan may be less than the lifetime of LED components, which would lead to unnecessary replacement of a luminaire with still working components. A further effect of using a fan is that, wherever there is a current of air, there is often a build up of dust, due to static electricity. Charged dust particles are often attracted to earthed heat sinks, fan blades and fan grilles, and this reduces the efficiency of any cooling system.

Some of conventional solutions to improve heat dissipation attempt to provide predetermined thermal connectivity between the light sources and at least some part of the luminaire and essentially try to use the luminaire as a heat sink for the light sources. Other conventional solutions contemplate improving the ability of the luminaire to dissipate heat into the environment and can range from increasing the surface area of the luminaire to prescribing predetermined lamp operating conditions as well as environmental conditions including power use patterns and requirements for minimum ventilation, distance and restricting the use of luminaires to within a range of predetermined ambient temperatures.

Known thermal management solutions sometimes include using heat spreaders to increase surface areas of LED-based light sources that can be used as replacements for conventional, for example, halogen and non-halogen incandescent lamps. These known LED-based light sources, however, typically attempt to provide good overall heat dissipation in relatively arbitrary directions.

The radiative cooling component of an LED is typically insignificant compared to thermal conduction and convection, which are more traditionally exploited. Thermal radiation is typically ineffective is due to the small size of the LED chip or LED package combined with a temperature much closer to room temperature than a filament or discharge. While radiator plates can be included in a luminaire as a means of cooling, there may not be enough physical space to include radiators of sufficient area.

Other known LED-based illumination systems utilize specially configured house or building windows as a form of light source for interior lighting. Such windows may include two spaced apart panes separated by thermally insulating means with light sources that are disposed at one pane to direct light in one direction and to direct heat in the opposite direction. The illumination system may be used in windows for providing interior lighting while avoiding conduction of heat via the interior face of the window. Another similar LED-based illumination system includes LEDs disposed on one side of an optical substrate. Light emitted by the LEDs is being emitted into and through the optical substrate to the side opposite the light sources. A layer of thermally conductive material is applied to the side of the optical substrate with the LEDs to act as a heat-spreading means. Both illumination systems, however, dissipate heat into space on one side of the light source while illuminating the other side.

### SUMMARY

The present disclosure is directed to inventive methods and apparatus for improving dissipation of heat within a lighting system and from a lighting system to the environment via a front end of the lighting system in the same general direction as its light emission.

Generally, in one aspect, the invention relates to a lamp which includes an LED-based light source configured to emit light in a first direction and an optically transmissive element which is optically and thermally coupled to the LED-based light source. The optically transmissive element is configured to transfer therethrough heat generated by the LED-based light source to the ambient substantially in the first direction

In some embodiments, the lamp further includes an optical system which is optically coupled to the LED-based light source and configured to redirect the light towards the optically transmissive element. The optically transmissive element can be coated with one or more layers of a first coating for improving emission of infrared radiation from the optically transmissive element at an interface between the optically transmissive element and the ambient. The first coating can be further configured to provide a predetermined heat conductivity. Also, the optically transmissive element can be coated with one or more layers of a second coating for improving reflection of infrared radiation into the optically transmissive element at an interface between the optically transmissive element and the interior of the lamp. The second coating can be further configured to provide a predetermined heat conductivity.

In one embodiment, the lamp further includes a heat pipe thermally coupling the LED-based light source to the optically transmissive element. The heat pipe can be thermally connected to the first and/or second coating.

The optically transmissive element may include one or more first elements comprising a first material having a first thermal conductivity and one or more second elements comprising a second material having a second thermal conductivity greater than the first thermal conductivity. According to certain embodiments, the first material is optically transparent. Also, the one or more second elements may define a honeycomb structure thermally connected to the one or more first elements.

In many embodiments, the lamp further includes a sealing system, wherein the optical system and the optically transmissive element define an interior space, wherein the sealing system, optical system and optically transmissive element cooperatively hermetically seal the interior space from the ambient. The interior space can be evacuated to a predetermined pressure.

According to various embodiments of the present invention, the optically transmissive element includes an integrally formed compound material, for example, a polycrystalline ceramic.

Generally, in another aspect, the invention focuses on a lamp including an LED-based light source (54) emitting light in a first direction; an optically transmissive element optically and thermally coupled to the LED-based light source, the optically transmissive element configured to transfer therethrough heat generated by the LED-based light source to the ambient substantially in the first direction; and an optical system optically coupled to the LED-based light source and configured to guide the light towards the optically transmissive element. The optical system and the optically transmissive element define an interior space evacuated to a predetermined pressure or filled with a thermally insulating fluid.

In yet another aspect, there is provided a method for dissipating heat from an LED-based light source of a lamp via an optically transmissive element of the lamp, the method comprising optically and thermally coupling the LED-based light source and the optically transmissive element, and configuring the optically transmissive element to transfer therethrough heat generated by the LED-based light source to the ambient environment outside the lamp.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

The term “light source” should be understood to refer to any one or more of a variety of radiation sources, including, but not limited to, LED-based sources (including one or more LEDs as defined above) and, other types of electroluminescent sources. A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources. A “multi-channel” lighting unit refers to an LED-based or non LED-based lighting unit that includes at least two light sources configured to respectively generate different spectrums of radiation, wherein each different source spectrum may be referred to as a “channel” of the multi-channel lighting unit.

The terms “lamp,” “lighting fixture” or “luminaire” are used herein to refer to an implementation or arrangement of one or more lighting units in a particular form factor, assembly, or package. More particularly, the term “lamp” as used herein refers a device for modular use in a lighting fixture and provides a source of light to the lighting fixture. A lamp may be configured to be readily replaced with another lamp of same or exchangeable type. A lamp generally includes one or more light sources or lighting units providing a source of light to the lamp.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrates a cross section of a lamp according to an embodiment of the invention.

FIG. 2 illustrates a cross section of a lamp according to another embodiment of the invention.

FIG. 3A illustrates a plan view of an optically transmissive element of a lamp according to an embodiment of the invention.

FIG. 3B illustrates an elevated view of the optically transmissive element illustrated in FIG. 3A.

FIG. 4 illustrates a plan view of an optically transmissive element of a lamp according to another embodiment of the invention.

FIG. 5A illustrates top view of a window for a lamp according to another embodiment of the invention.

FIG. 5B illustrates a cross section A-A of the window of FIG. 5A.

FIG. 6 illustrates a cross section of a lamp according to an embodiment of the invention.

FIG. 7 illustrates a cross section of a lamp according to another embodiment of the invention.

FIG. 8 illustrates a cross section of a lamp according to yet another embodiment of the invention.

FIG. 9 illustrates a cross section of a lamp according to still another embodiment of the invention.

### DETAILED DESCRIPTION

As with the configuration of lamps in general, heat dissipation in LED lamps using a LED-based light source can be challenging. LEDs can generate substantial amounts of heat while generally requiring much lower operating temperatures than filaments in incandescent lamps. For example, a LED lamp that is designed to be used as a replacement for one of the many existing types of incandescent lamps may require different heat dissipation characteristics than its incandescent counterpart to be able to prevent overheating of the LEDs in the lamp. Configuring the LED lamp as a heat sink so that it simply releases heat somewhere into the environment may not be enough to sufficiently cool the LEDs in the lamp. Dissipating heat in just arbitrary directions from just any part of the LED lamp may cause heat accumulation specifically when the LED lamp is used in combination with certain types of fixtures. A LED lamp therefore may need to be configured to provide desired thermal management characteristics. More generally, Applicants have recognized and appreciated that it would be beneficial to dissipate heat away from the lamp effectively in directions in which the LED lamp or a corresponding fixture emit light into the environment.

In view of the foregoing, various embodiments and implementations of the present invention are directed to a thermally managed lamp.

According to an aspect of the present invention, a LED lamp is provided that includes a LED-based light source. The LED-based light source can include one or more LEDs. The lamp includes an optically transmissive element that is optically and thermally coupled to the LED-based light source. The lamp and specifically the optically transmissive element are configured to transfer heat generated by the LED-based light source to the outside of the lamp through the optically transmissive element. The lamp may further employ an optical system that is optically coupled to the LED-based light source, wherein the optical system is configured to redirect light from the LEDs toward the optically transmissive element.

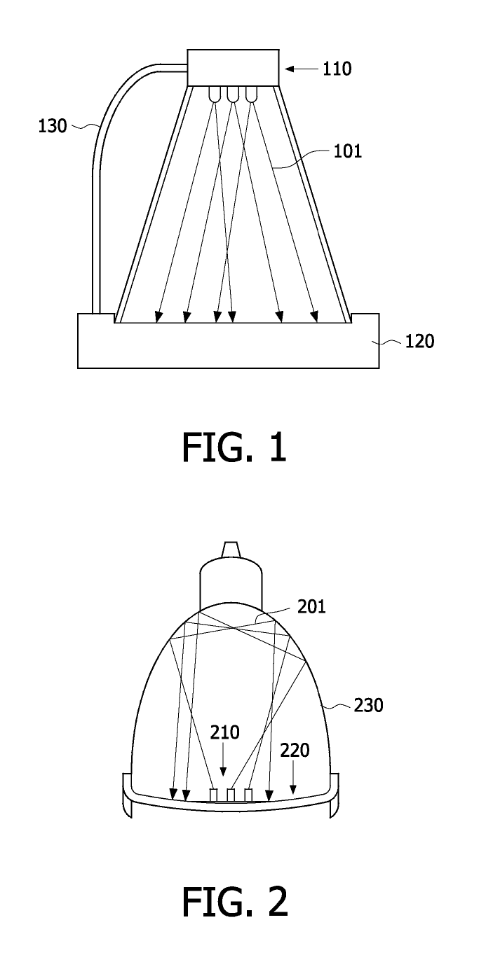

A cross-section of a lamp according to some embodiments of the present invention is illustrated in FIG. 1. The lamp includes at least one LED-based light source 110 and an optically transmissive element 120. The lamp is generally configured to direct light emitted by the LED-based light source 110 substantially along optical paths 101 toward the optically transmissive element 120. The lamp further includes a heat pipe 130 which thermally connects the optically transmissive element 120 and the LED-based light source 110, and is configured to transfer heat to the ambient through the optically transmissive element.

A cross section of a lamp according to other embodiments is illustrated in FIG. 2. The lamp includes a LED-based light source 210 and an optically transmissive element 220. The lamp further includes a reflector 230 which optically connects 201 the optically transmissive element 220 and the LED-based light source 210. The LED-based light source 210 is disposed so that it substantially emits light directly towards the reflector 230 from which the light is substantially reflected. Light may be reflected toward the optically transmissive element 220 or the reflector 230. The lamp according to these embodiments is configured to substantially redirect light emitted by the LED-based light source 210 along an optical path via the reflector 230 toward the optically transmissive element 220. The lamp is further configured to transfer heat from the LED-based light source 210 substantially to the optically transmissive element 220 and through the optically transmissive element 220 to the ambient.

### Optically Transmissive Element

The optically transmissive element may be configured to provide at least part of an inner or outer hull of the lamp. The optically transmissive element may have a flat, generally curved, bulb, pear, tube or other shape depending on the embodiment. The optically transmissive element may have a predetermined thickness profile, surface texture or surface roughness that may, at least in part, be determined to provide the optically transmissive element with predetermined optical characteristics. In order to dissipate heat across and through the optically transmissive element, in some embodiments, the optically transmissive element is configured to provide integral thermal conductivity. For example, good integral thermal conductivity can provide the optically transmissive element with the ability to assume a more homogenous temperature profile with low temperature gradients and the ability to dissipate substantial amounts of heat.

In some embodiments, the optically transmissive element may be optionally coated with one or more layers of a first coating at least at a portion of an interface between the optically transmissive element and the outside of the lamp. The first coating can be configured to provide a desired emissivity for infrared as well as visible and other non-visible radiation from the optically transmissive element to the outside of the lamp. The first coating may be further configured to provide a predetermined heat conductivity. Heat transfer through the optically transmissive element can further be affected by convection of an outside medium. The outside medium may be air or water, for example, or another substance depending on the application of the lamp. The first coating may be further configured to provide predetermined combined convection and radiation heat transfer characteristics.

In some embodiments, the optically transmissive element may be optionally coated with one or more layers of a second coating to provide reflection of infrared as well as visible and other non-visible radiation into the optically transmissive element at least at a portion of an interface between the optically transmissive element and an interior of the lamp. The second coating also may be further configured to provide predetermined heat conductivity. Similar considerations apply regarding convection adjacent the second coating facing the interior of the lamp respective of those for the first coating at the outside. The second coating may therefore also be configured to provide a predetermined convection heat transfer characteristic. The convection heat transfer characteristic of the second coating may be high or low depending on the embodiment.

A number of configurations of single and multi-layer first and second coatings can be envisioned. It is noted that considerations regarding the radiation and convection heat transfer characteristics of the first and second coating may also apply if the optically transmissive element is not coated or to respective surfaces of the optically transmissive element that are not coated.

In some embodiments, the first and/or the second coating can be configured to provide predetermined transmittance for infrared or non-visible radiation while also providing predetermined transmittance for visible light. According to an embodiment of the present invention, the coatings can be configured to provide a predetermined ratio between the transmittance for visible light and the transmittance for infrared or non-visible radiation. Similar considerations can apply for determining the material composition of the optically transmissive element.

In some embodiments, the optically transmissive element may comprise an integrally formed compound material. For example, the optically transmissive element may comprise an amorphous, crystalline or polycrystalline material, one of the many varieties of glass or transparent plastics, or ceramics such as highly pure or doped yttrium aluminum garnet, polycrystalline alumina or aluminum nitride or other suitable materials.

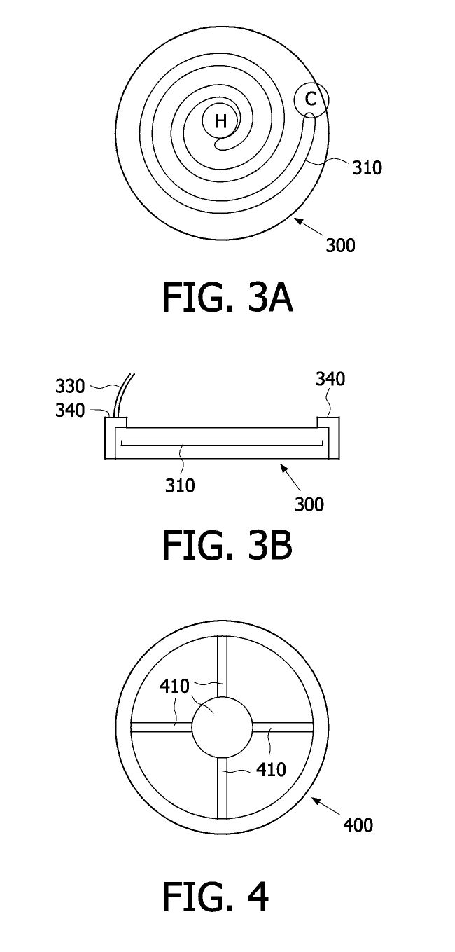

According to some embodiments of the present invention, the optically transmissive element may be configured to include an integrally formed heat pipe or comprise at least part of a heat pipe to provide good heat dissipation within and allow for effective thermal coupling to the optically transmissive element. An integrally formed heat pipe can be configured to dissipate heat very effectively throughout the optically transmissive element. Integrally formed heat pipes may be configured in a number of ways as illustrated in FIG. 3A and FIG. 3B, or FIG. 4, for example.

FIG. 3A illustrates a plan view of an optically transmissive element 300 that includes a spiral shaped heat pipe 310. The heat pipe 310 may be at least partiallyt transparent or translucent. FIG. 3B illustrates an elevated view of the optically transmissive element of FIG. 3A. FIG. 3B also illustrates a frame 340 for operatively disposing the optically transmissive element 300 and further illustrates a portion of an external heat pipe 330 operatively connected to the frame 340 for thermally connecting an LED-based light source (not illustrated). The FIG. 4 illustrates another example of an optically transmissive element 400 without a frame. The heat pipe 410 of the optically transmissive element illustrated in FIG. 4 is shaped as a ring with protruding spokes. The ring and the spokes may be integrally formed or separate depending on the embodiment. It is noted that optically transmissive elements such as 300 or 400, for example, may be configured to provide predetermined heat transfer characteristics in substantially radially inward or outward direction or in both directions. In some embodiments, the external heat pipe and the optically transmissive element are thermally interconnected via the frame. In other embodiments, the external heat pipe can be integrally interconnected with the heat pipe of the optically transmissive element (not illustrated).

According to other embodiments, the optically transmissive element may be configured to refract light in a predetermined way. The refractive characteristics of the optically transmissive element may be determined by one or more properties including the geometry or material composition of the optically transmissive element or one or more of its surfaces or interfaces, for example, as well as the first coating and/or the second coating, if the optically transmissive element is coated.

In some embodiments, the optically transmissive element may be formed as a planar, non-planar or a three-dimensional geodesic composite object from one or more first elements comprising a first material and one or more second elements comprising a second material. To ensure good thermal connectivity throughout the optically transmissive element, intimate thermal contact between the first and second elements is required. Intimate thermal contact may be provided, for example, by integrally forming the first and second elements. Furthermore, thermal contact can be facilitated, for example, by employing materials with adequately similar thermal expansion coefficients, by pressure fitting the first and second elements, or by configuring the first and second elements so that they provide a pressure fit at least under operating temperature conditions.

The one or more second elements may be configured to define a planar or non-planar structure for disposing the one or more first elements. The one or more first elements may be configured to have irregular or regular shapes including triangular, quadratic, pentagonal, hexagonal or so forth shapes, for example. The second material may have a thermal conductivity greater than the first material. At least one of the two materials may be optically transparent.

According to some embodiments, the interfaces between the first and second elements of the optically transmissive element may be configured to provide further predetermined optical characteristics. For example, the interfaces may be configured to provide predetermined shaped cross sections and/or interface roughness.

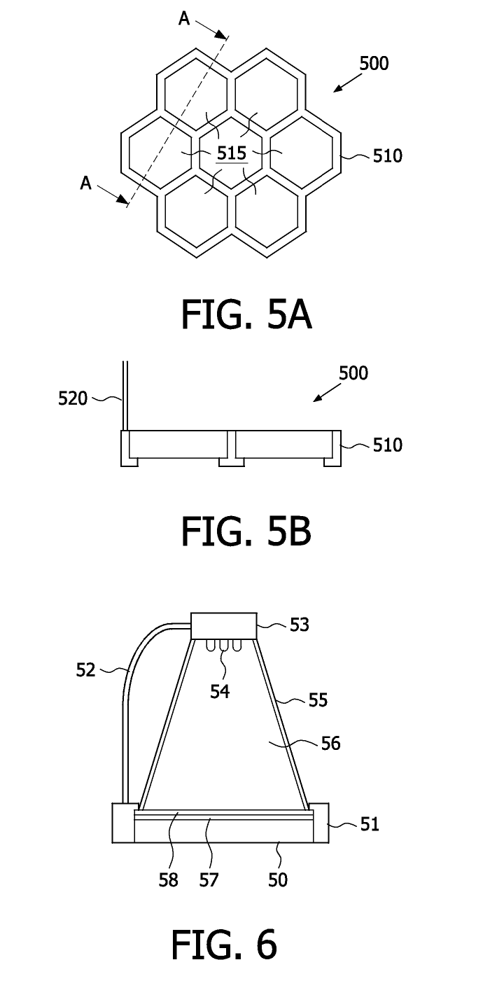

FIG. 5A and FIG. 5B illustrate a suitable composite optically transmissive element 500. FIG. 5A illustrates a top view and FIG. 5B illustrates a cross section along the line A-A of FIG. 5A. The composite optically transmissive element 500 has a honeycomb structure 510 and optically transparent modules 515. The honeycomb structure is thermally connected to a heat pipe 520, which is configured to transfer heat generated by the LED-based light source (not illustrated) to the optically transmissive element.

### Thermal Connection Between Light Source and Optically Transmissive Element

A lamp according to embodiments of the present invention may employ a heat pipe for thermally coupling the LED-based light source to the optically transmissive element. The heat pipe may be optionally thermally connected to the first or the second coating or to both coatings. Moreover, at least a part of the heat pipe may be optionally integrally formed with the optically transmissive element.

A lamp according to embodiments of the present invention may be configured so that the thermal connection between the LED-based light source and the optically transmissive element is facilitated by the optical system. For example, the optical system may include one or more heat pipes or materials of desired thermal conductance for thermally coupling the LED-based light source and the optically transmissive element.

A lamp according to embodiments of the present invention may be configured so that the LED-based light source is disposed on an inner side of the optically transmissive element, wherein the optically transmissive element is configured to transfer heat from the inner side to its outer side and from the outer side to the ambient. The lamp may be further configured so that the LED-based light source is thermally conductively connected to the inner side. The LED lamp may be configured so that the LED-based light source emits light towards or right into the optically transmissive element.

It is noted that a lamp according to embodiments of the present invention may comprise one or more heat pipes irrespective of whether LEDs are disposed on, or remotely disposed from the optically transmissive element.

### Optical System

In some embodiments, the optical system includes a number of optical elements that can refract and/or reflect at least visible but also infrared and/or ultraviolet light and may include elements comprising photoluminescent materials. The optical system may be configured to provide predetermined color-mixing and/or beam-shaping characteristics either by itself or in combination with the optically transmissive element.

In some embodiments, the optical system may be configured to provide thermal connectivity between the LED-based light source and the optically transmissive element. According to embodiments of the present invention, the optical system includes at least one heat pipe.

### Sealing System

The lamp may optionally employ a sealing system that, in cooperation with one or more other components of the lamp such as the optical system and/or optically transmissive element, for example, to hermetically seal an interior space of the lamp. The interior space may be defined by the optical system and the optically transmissive element, for example. The interior space may be filled with a fluid substance selected to provide a predetermined high or low thermal conductivity depending on the desired effect. The fluid substance may be a gas and/or a liquid. If filled with a gas, the interior space may be filled to a predetermined pressure. According to other embodiments, the interior space may be evacuated to a predetermined pressure.

The invention will now be described with reference to specific examples. It will be understood that the following examples are intended to describe embodiments of the invention and are not intended to limit the invention in any way.

### EXAMPLE 1

FIG. 6 illustrates a cross section of yet another exemplary lamp according to an embodiment of the present invention. The optically transmissive element of the lamp includes a window 50 which may be configured in a manner as described above, for example, from an integrally formed compound material or a portion of a geodesic dome. The optically transmissive element has a low emissivity coating 58 and transparent diamond coating 57 disposed, for example by means of chemical vapor deposition, on the inside of window 50. As illustrated in FIG. 6, the exemplary lamp further includes a heat pipe 52 that is configured to transport heat generated by the LEDs 54 from substrate 53 to the window 50. The optical system includes walls 55 configured to reflect light back into the interior space 56, for example, toward the optically transmissive element. The LEDs 54 are operatively connected to a controller and power source (not illustrated).

The interior space 56 can be configured to provide poor heat transfer characteristics (not illustrated). The illustrated example lamp is configured to provide enhanced thermal connection between the LEDs 54 and the window 50 and diminish thermal conductivity to the remainder of the components of the lamp, for example the walls 55. In addition, the walls 55 can also be configured to be poor thermal conductors, for example, for example the walls can be fabricated from a material which acts as a thermal insulator.

The interior space 56 may be filled with a fluid (not illustrated) that provides poor heat transfer between components of the lamp such as the LEDs 54, the substrate 53 or the walls 55, for example, and the window 50 via the fluid. Alternatively the interior space may be evacuated to a predetermined pressure or filled with a fluid that provides little heat transfer, for example a fluid which acts as a thermal insulator. The fluid may be an adequate gas, for example, air, argon, krypton, nitrogen, or carbon dioxide, or other substances would be readily understood by a worker skilled in the art and may be selected based on the desired thermal conductivity.

Other lamps (not illustrated) may be configured to provide good thermal insulation between the walls 55 and substrate 53. Depending at least in part on the outside surface area of the walls 55, the ability of the outside surface of the walls to release heat into the environment, but primarily on the amount of heat that is intended to be transferred via the walls 55 to the outside. Such an example lamp may be evacuated or filled with a suitable fluid to provide the interior space with poor heat transfer characteristics.

### EXAMPLE 2

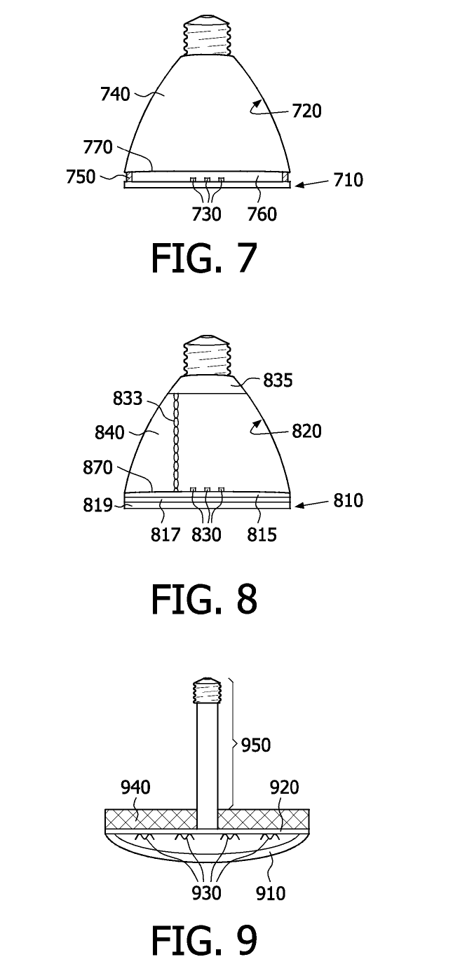

FIG. 7 illustrates a cross-section of another exemplary lamp. The LEDs 730 of the lamp are operatively disposed on or proximate the interior surface of the optically transmissive element 710. The LEDs 730 may be operatively disposed on a separate substrate (not illustrated) that is disposed on and thermally connected to the optically transmissive element.

The LEDs 730 are operatively connected to a controller and power source (not illustrated) for controlling the LEDs. The LEDs are oriented so they emit light substantially away from the optically transmissive element 710. An optically transparent membrane 770 separates interior space 740 from separation space 760 formed by a thermally insulating distance ring 750. Separation space may be filled with air or be evacuated, for example.

The interior space 740 of the example lamp is evacuated to suppress convection of heat via interior space. The membrane 770 and the reflector 720 are configured to reflect infrared radiation down toward the optically transmissive element 710. The lamp is configured so that heat generated by LEDs 730 is substantially dissipated into the optically transmissive element, which in turn is configured to spread heat substantially throughout the optically transmissive element so it can assume a temperature profile with low temperature gradients. The optically transmissive element is further configured to substantially release heat from its outside surface into the ambient. The optically transmissive element can include an integrally formed heat pipe, for example.

### EXAMPLE 3

FIG. 8 illustrates a cross-section of yet another exemplary lamp. The LEDs 830 of the lamp are operatively disposed on or proximate the interior surface of the optically transmissive element 810. The LEDs 830 may be operatively disposed on a separate substrate (not illustrated) that is disposed on and thermally connected to the optically transmissive element.

The optically transmissive element 830 of this lamp includes low infrared emissivity coating 815, high thermal conductivity coating 817 and glass disk 819. The low infrared emissivity coating is disposed on and thermally connected to coating which is disposed on and thermally well connected to disk 819. Low infrared emissivity coating is configured to suppress emission of infrared heat into interior space 840. Coating may be made of a number of materials including indium tin oxide, diamond, or other adequate, readily known material, for example. The thicknesses of coatings 815 and 817 as well as that of disk 819 are not illustrated to scale.

The LEDs 830 are operatively connected 833 to a controller and power source for controlling the LEDs included in 835. The LEDs are oriented so they emit light away from the optically transmissive element 810 toward reflector 820. The interior space 840 of the example lamp is evacuated to suppress convection of heat via the interior space. The reflector 820 is configured to reflect infrared radiation down toward the optically transmissive element 810.

The lamp is configured so that heat generated by LEDs 830 is substantially dissipated into the optically transmissive element 810, which in turn is configured to spread heat substantially throughout itself so it can assume a temperature profile with low temperature gradients. The optically transmissive element 810 is further configured to substantially release heat from its outside surface into the ambient. The optically transmissive element 810 can include an integrally formed heat pipe, for example.

### EXAMPLE 4

FIG. 9 illustrates a cross section of still another exemplary lamp. The LEDs 930 of the lamp are disposed on a substrate 920 which is configured to provide predetermined thermal conductivity and, while operatively connected to, is thermally insulated from upper part 950 of the lamp. The substrate may comprise one or more layers of electrically conducting or insulating as well as thermally conducting or insulating materials in order to facilitate operative connection between the LEDs and a power source and/or controller (not illustrated) which may be integrated in the upper part 950 of the lamp. The LEDs 930 are operatively connected to a controller and power source (not illustrated).

Thermal insulation 940 is disposed adjacent the substrate 920 opposite the LEDs 930. The optically transmissive element of this exemplary lamp defines a window 910 which is configured to provide high thermal emissivity via radiation. In addition, heat may also be distributed to the ambient via convection from the outer surface of the window, for example. The mechanical connection between the window and the substrate may be configured to provide good thermal conductance. For example, the window and substrate may be integrally formed and/or thermally connected using a heat pipe. In some embodiments, the space between substrate 920 and window 910 may be filled with a transparent fluid which is a good thermal conductor, wherein this transparent fluid may be a gas or a liquid.

The window 910 can be formed as an integrally shaped body comprising one or more at least optically transmissive materials. The window may be configured to provide a predetermined single or multi-layer composition, thickness profile, surface texture or surface roughness to provide predetermined optical refraction and/or reflection characteristics. The window may be configured in composite form and shaped as a part of a geodesic dome (not illustrated).

The LEDs 930 are disposed so they emit light toward the window 910. Each of the LEDs may be disposed in combination with a reflector for reflecting the light emitted by each of the LEDs. The surface of the substrate 920 proximate the LEDs may be coated with an optically and/or infrared reflective coating. The lamp is configured to provide a combination of predetermined illumination and heat dissipation characteristics.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively

Finally, the reference numerals in the claims are merely for convenience and are not to be read in any way as limiting.

1. A lamp comprising:
an LED-based light source emitting light in a first direction; and
an optically transmissive element optically and thermally coupled to the LED-based light source, the optically transmissive element configured to transfer therethrough heat generated by the LED-based light source to the ambient substantially in the first direction.

2. The lamp according to claim 1, further comprising an optical system optically coupled to the LED-based light source and configured to guide the light towards the optically transmissive element.

3. The lamp according to claim 2 further comprising a sealing system, wherein the optical system and the optically transmissive element define an interior space, the sealing system, the optical system and the optically transmissive element cooperatively seal the interior space from the ambient.

4. The lamp according to claim 1, wherein the optically transmissive element is coated with one or more layers of a first coating for facilitating emission of infrared radiation from the optically transmissive element at an interface between the optically transmissive element and the ambient.

5. The lamp according to claim 4, wherein the first coating has a predetermined thermal conductivity.

6. The lamp according to claim 1, wherein the optically transmissive element is coated with one or more layers of a second coating for facilitating reflection of infrared radiation into the optically transmissive element at an interface between the optically transmissive element and an interior of the lamp.

7. The lamp according to claim 6, wherein the second coating has a predetermined thermal conductivity.

8. The lamp according to claim 1, further comprising a thermally conductive element thermally connecting the LED-based light source and the optically transmissive element.

9. The lamp according to claim 8, wherein the thermally conductive element is a heat pipe.

10. The lamp according to claim 1, wherein the optically transmissive element comprises one or more first elements including a first material having a first thermal conductivity and one or more second elements including a second material having a second thermal conductivity greater than the first thermal conductivity.

11. The lamp according to claim 10, wherein the first material is optically transparent.

12. The lamp according to claim 10, wherein the one or more second elements define a honeycomb structure thermally connected to the one or more first elements.

13. The lamp according to claim 1, further comprising a heat pipe at least partially embedded in the optically transmissive element.

14. The lamp according to claim 1, wherein the LED-based light source is disposed on and thermally conductively connected to the optically transmissive element.

15. A lamp comprising:
an LED-based light source emitting light in a first direction;
an optically transmissive element optically and thermally coupled to the LED-based light source, the optically transmissive element configured to transfer therethrough heat generated by the LED-based light source to the ambient substantially in the first direction; and an optical system optically coupled to the LED-based light source and configured to guide the light towards the optically transmissive element, wherein the optical system and the optically transmissive element define an interior space evacuated to a predetermined pressure or filled with a thermally insulating fluid.

16. The lamp according to claim 15, further comprising a thermally conductive element thermally connecting the LED-based light source and the optically transmissive element.

17. The lamp according to claim 16, wherein the thermally conductive element is a heat pipe.

18. The lamp according to claim 16, wherein the optically transmissive element comprises one or more optically transparent first elements including a first material having a first thermal conductivity and one or more second elements including a second material having a second thermal conductivity greater than the first thermal conductivity.

19. The lamp according to claim 16, wherein the one or more second elements define a honeycomb structure thermally connected to the one or more first elements.

20. A method for dissipating heat from an LED light source of a lamp via an optically transmissive element of the lamp, the method comprising:
optically and thermally coupling the LED light source and the optically transmissive element; and
configuring the optically transmissive element to transfer therethrough heat generated by the LED light source to outside the lamp.
